(19) United States
(12) Patent Application Publication
(10) Pub. No.: US 2006/0268329 A1
(43) Pub. Date: Nov. 30, 2006

(54) System and method for wireless signal transmission

(76) Inventor: Shoa Hung Lo, Taipei City (TW)

Correspondence Address: VOLENTINE FRANCOS, & WHITT PLLC, ONE FREEDOM SQUARE, 11951 FREEDOM DRIVE SUITE 1260, RESTON, VA, 20190, US

(21) Appl. No.: 11/414,209

(22) Filed: May 1, 2006

(30) Foreign Application Priority Data
May 27, 2005 (TW) 094117487

(51) Int. Cl. G06F 3/12

(52) U.S. Cl. 358/1.15; 358/1.13; 358/1.6

(57) ABSTRACT

A wireless signal transmission system and method establishes an inter-transmission and exchange of files between a computer peripheral and a host system through a wireless signal transmission module. The system at least has an integrated Bluetooth module and a USB chip, which can intelligently identify and convert the type of wireless data format into wired interface data format. Through the wired interface port in connection with the host system, the type of the computer peripheral is reported to the host system. Accordingly, various drivers for different wireless peripherals need not be installed repeatedly, so as to increase the convenience and usefulness of the operation.

### BACKGROUND OF THE INVENTION

(A) Field of the Invention

The present invention relates to a system and a method for wireless signal transmission, and more particularly, to computer peripherals connected to an intelligent reporting computer system and the data transmission or exchange between them.

(B) Description of the Related Art

Bluetooth is a wireless communication technique jointly announced by Ericsson, Nokia, Toshiba, IBM and Intel in May 1998. Its advantages include being able to automatically recognize and identify remote equipment with the Bluetooth function within a certain distance; switching into sleeping status when not being used, i.e., the feature of power-saving; and having a one-to-one or one-to-multi communication feature. In addition, compared with other wireless transmission techniques, Bluetooth can resolve the issues of only performing the data transmission between static equipments, which may occur in a remote controller or when using infrared rays. In other words, Bluetooth has the advantage in performing wireless communication for moving equipment. Furthermore, even though an electromagnetic wave of Bluetooth is blocked by an obstacle, it can penetrate the obstacle and make transmission possible.

Universal Serial Bus (USB), another transmission specification, was announced by Intel early in late 1994, and officially brought out with the support of Compaq, Microsoft, NEC, IBM, Northern and Telcom. USB is characterized by plug-and-play, hot attach and detach, bus power supply and high speed of transmission (the highest can be 480 Mbps). Such transmission speed has been able to satisfy the data transmission requirement for most peripheral equipments, particularly after USB 2.0 was announced.

In view of the above, these two types of techniques are integrated as one to keep the strength of both and get rid of the shortcomings, and therefore the relevant product becomes much more friendly and useful. However, with this known product, when communication is established between a computer and a wireless equipment, the computer cannot inform the user what the connected equipment is, and instead treats it as an unknown equipment. The computer needs to run an additional driver to identify the connected wireless equipment. Since transmission signals for the wireless equipment may not be the same, corresponding drivers have to be installed in the computer for signal recognition. Therefore, this known product is quite inconvenient to use, consumers' desire to purchase it would decrease.

### SUMMARY OF THE INVENTION

The objective of the present invention is to provide a system or an apparatus with a built-in conversion program that can directly recognize types of the connected wireless equipment on the basis that other drivers are not needed in the computer system. Accordingly, the operation becomes more convenient and easier.

Furthermore, the conversion program has a default signal that can actively report the type of the connected computer peripheral to the host computer, so that the host can determine the most suitable connection path and then perform the data transmission or exchange with the most suitable software.

Another objective of the present invention is to allow the conversion of the data format from wireless signal into wired interface signal in the system or apparatus. Consequently, the advantages of both the Bluetooth technique and the transmission speed of wired interface can be integrated, and therefore the present invention will be more competitive in the market.

Moreover, because a wired interface is occupied when a peripheral is connected to a computer, an additional peripheral cannot be connected to the computer. Nevertheless, the number of wired interface slots in the host system, which is limited at present, can be increased in accordance with the present invention. In other words, the present invention, based on wireless technique communication protocol, can increase the connections of more than one computer peripheral.

### BRIEF DESCRIPTION OF THE DRAWINGS

Embodiments of the present invention will now be described with reference to the accompanying drawings:

FIG. 1 is a schematic view illustrating the connection among multi-computer peripherals through wireless transmission in accordance with the present invention;

FIG. 2 is a diagram illustrating the use of the Bluetooth and the USB interface to connect a computer and peripherals in accordance with the present invention;

FIG. 3 is a diagram illustrating a process of a wired interface in connection with a wireless signal transmission module in accordance with the present invention;

FIG. 4 is a flow chart illustrating the wireless receiving and transmission between the host system and computer peripheral in accordance with the present invention; and

FIG. 5 is a flow chart illustrating an embodiment of wireless data transmission between a computer and a Bluetooth mobile phone in accordance with the present invention.

### DETAILED DESCRIPTION OF THE INVENTION

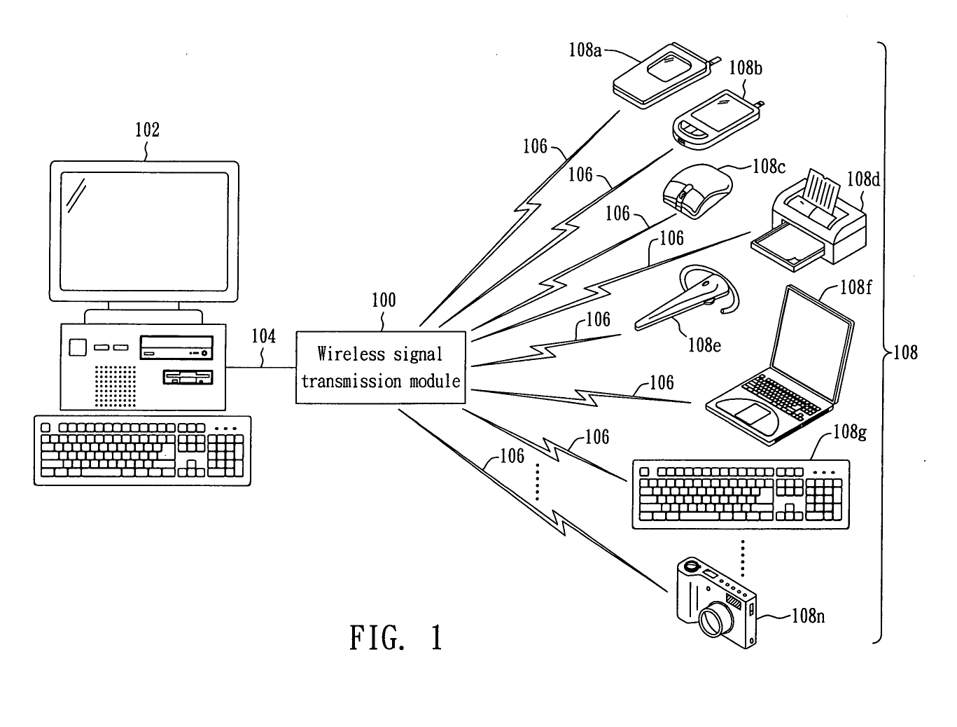

FIG. 1 shows an embodiment of the present invention. A wireless signal transmission module 100 establishes a connection between a host system 102 and one or more computer peripherals 108, e.g., synchronized data transmission, receiving/sending e-mails, browsing webpages or printing files with a wireless printer and accessing Internet data through a mobile phone with wireless communication support. The host system 102 may be a desktop computer, a laptop, a PDA, or the like; the connected computer peripheral 108 may be a wireless mobile phone 108a, a wireless personal data assistant 108b, a wireless mouse 108c, a wireless printer 108d, a wireless earphone 108e, a wireless laptop 108f, a wireless keyboard 108g, a wireless digital camera 108n or other information appliances (IA). According to Bluetooth communication protocol, the host system 102 may be connected to up to one of the computer peripherals 108, or be connected to seven computer peripherals 108 together through electromagnetic waves 106, and the transmission speed depends on bandwidth. Among these, the host system 102 is defined as a master, whereas the other equipment is defined as slave.

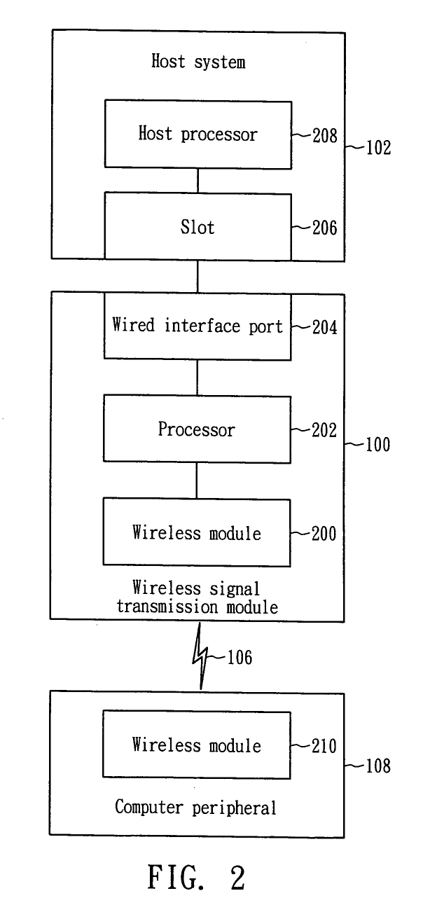

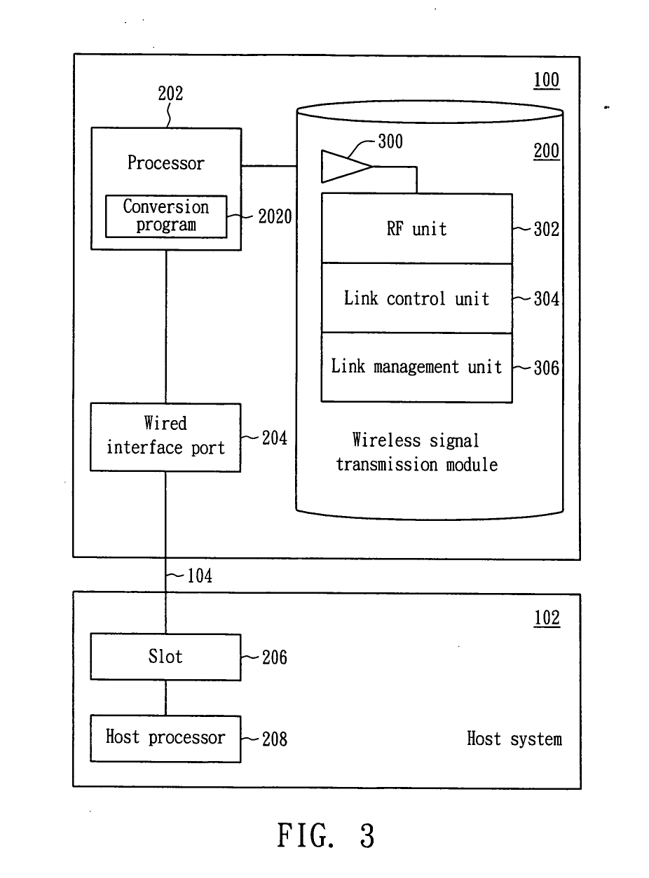

Referring to FIGS. 2 and 3, if a computer peripheral 108 is embedded with a wireless module 210, it can intercommunicate with the wireless signal transmission module 100 of the present invention. The wireless signal transmission module 100 at least comprises a wireless module 200, a processor 202 and a wired interface port 204. The wireless module 200, when it is in compliance with Bluetooth, further includes a hidden antenna 300, a radio frequency (RF) unit 302, a link control unit 304 and a link management unit 306. The hidden antenna 300, radio frequency unit 302, link control unit 304 and link management unit 306 are under the rule of Bluetooth communication protocol (the same for the wireless module 210 of the computer peripheral 108). The wireless signal transmission module 100 of this embodiment is designed with two independent chips of the wireless module 200 and processor 202. In practice, the two chips of the wireless module 200 and processor 202 can be integrated as one chip to make wireless technique adopted more widely.

The processor 202 has a built-in conversion program 2020 to support at least 16 types of data including Dial-Up Network (DUN), Fax, LAN Access (LAP), Serial Port (SPP), Human Interface Device (HID), Hardcopy Cable Replacement (HCRP), File Transfer (FTP), Object Push (OPP), Personal Area Network (PAN), Basic Image Profile (BIP), Headset (HSP), Generic Access (GAP), Service Discovery Application (SDAP), Synchronization (SYNC), Generic Object Exchange (GEOP), and Audio Gateway (AGP).

According to the above data formats, when the wireless module 200 receives a receiving data stream in a wireless format, the conversion program 2020 built in the processor 202 that is coupled to the wireless module 200 will intelligently identify the receiving data stream of the wireless format and convert the receiving data stream from the wireless format into a wired interface format, and then send an inserting wired interface signal and identify the type of the connected computer peripheral 108. In other words, the conversion program 2020, which is pre-written according to the above data formats, is able to identify the receiving data stream of the wireless format as well as to convert the receiving data stream to a wired format. The slot 206 is connected to the wired interface port 204 of the host system 102 directly or by a cable 104. The conversion program 2020 reports a predetermined signal indicating the type of the connected equipment to the host system 102 when the signal connection is established, and then the host system 102 activates the most suitable software for the data transmission or exchange according to the type of equipment. The product with this design is quite convenient for the user.

The conversion program 2020 is commonly called code or firmware in this field. The wired interface port 204 may be a USB interface, IEEE1394 interface or other wired interfaces. The processor 202 and host processor 208 are capable of supporting various wired interfaces. The wireless technique used in the present invention may be, but is not limited to, Bluetooth, Wi-Fi or ZigBee (also called IEEE 802.15.4 standard). The wireless signal transmission module 100 can be produced as an adapter, e.g., a USB/Bluetooth adapter, IEEE1394/Bluetooth adapter or other adapter with wired interface and wireless transmission apparatus integrated.

The method of receiving data sent from the computer peripheral 108 to the host system 102 has been described above. The operation method of reverse data transmission is described below. In brief, the processor 202 receives a data stream in a wired format from the host system 102 through the wired interface port 204, and then the conversion program 2020 converts the data stream from the wired format into a wireless format and transmits the data stream in the wireless format to the computer peripheral 108 through the wireless module 200.

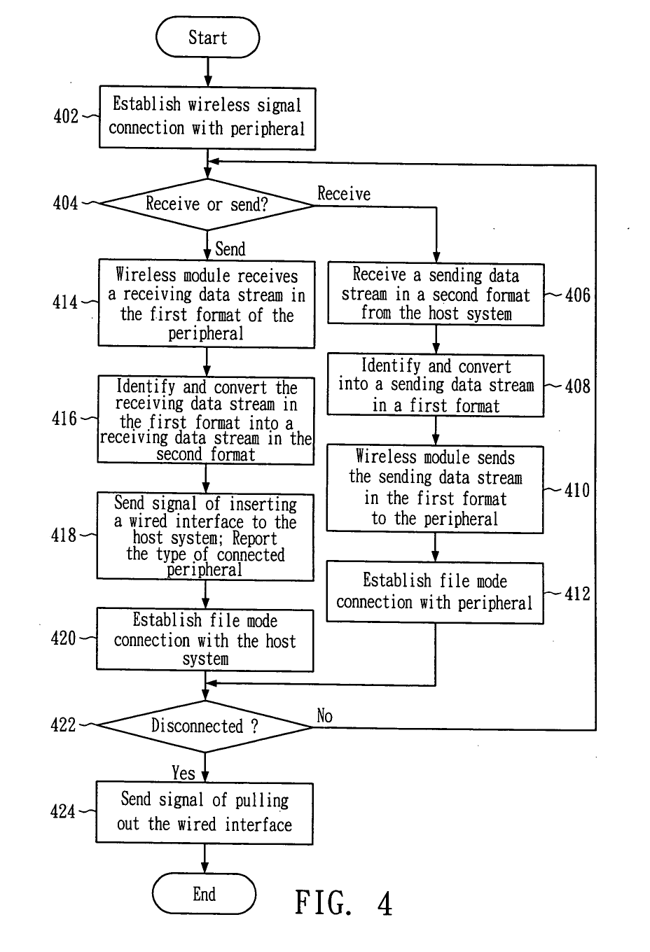

Referring to FIG. 4, it further illustrates the flow chart to show how wireless data are received and sent in accordance with the present invention. First, the wireless signal is detected and the wireless signal connection between the wireless signal transmission module and the computer peripheral is established (step 402). The next step is to determine if the data will be received or sent (step 404). If data is going to be sent, the wireless module will receive the receiving data stream in the first format from the computer peripheral (step 414), and then identify and convert the receiving data stream in the first format into a receiving data stream in the second format (step 416). Afterwards, the wireless module sends a signal of inserting a wired interface into the host system, reports the type of connected computer peripheral (step 418) and establishes the file connection mode with the host system (step 420). During the process, the data stream in the first format is the data stream in general wireless format, e.g., the 16 types of Bluetooth data mentioned above, and the data stream in the second format is the data stream in general wired interface format, e.g., data format in USB interface, IEEE1394 interface or other wired interfaces. Sequentially, it must be determined whether the connection is disconnected (step 422). If it is disconnected, the signal of pulling out the wired interface is sent directly (step 424) and data transmission is stopped. If it is not disconnected, step 404, determining the intention to receive or send data, is returned.

In addition, when the computer peripheral starts to receive data or files from the host system, the sending data stream in the second format is sent from the host system (step 406), and the conversion program of the wireless signal transmission module identifies and converts the sending data stream in the second format into the sending data stream in the first format (step 408). The wireless module of the wireless signal transmission module sends the sending data stream in the first format to the computer peripheral (step 410) and establishes file connection mode with the computer peripheral (step 412). The user already knows what the connected equipment is when the host system starts to send data to the computer peripheral and will select appropriate software for data transmission or exchange. Then, it is determined whether or not the connection is disconnected (step 422). If it is disconnected, the signal of pulling out the wired interface is sent directly (step 424) and data receiving is stopped. If it is not disconnected, step 404, determining the intention to receive or send data, is returned. The subsequent steps are repeated as mentioned above, and therefore the detailed descriptions are omitted herein.

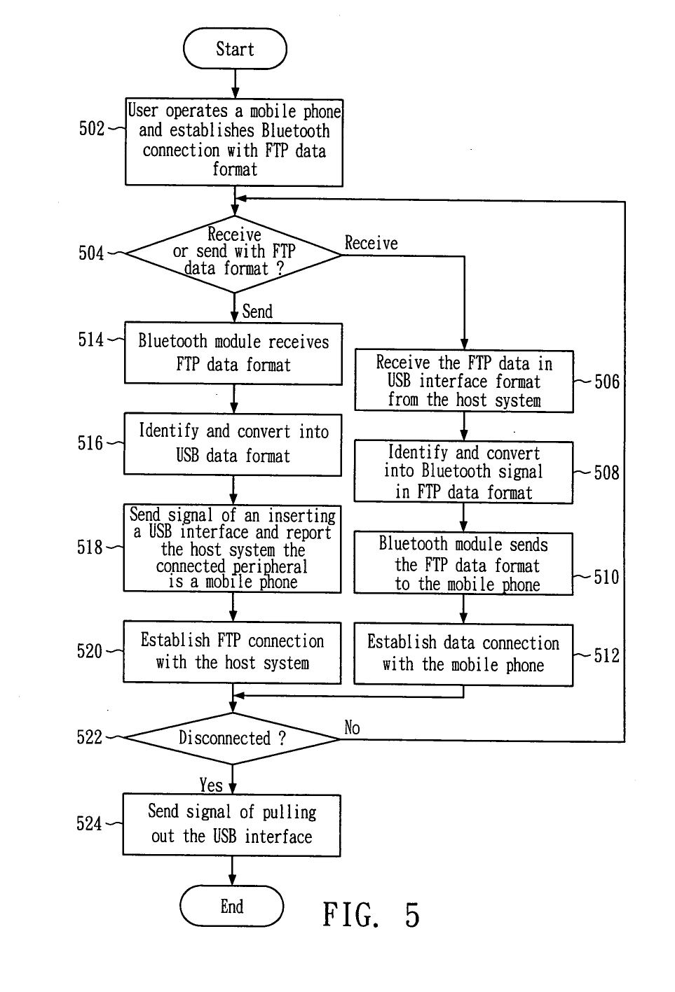

FIG. 5 further illustrates a flow chart of an actual operation method for an example regarding a Bluetooth mobile phone and a USB interface port. The user operates the mobile phone, establishes the Bluetooth connection with FTP data format (step 502) and decides if the file is going to be received or sent (step 504). If the file is going to be sent, the Bluetooth module receives the file with FTP data format from the Bluetooth mobile phone (step 514), identifies and converts the file into USB data format by the conversion program (step 516), sends a signal of inserting USB interface into the host system, reports to the host system that the connected equipment is a mobile phone (step 518) and establishes data connection mode with the host system (step 520). In this embodiment, the wireless signal transmission module 100 is a Bluetooth wireless signal transmission module, the processor has a USB interface and includes a chip having a conversion program for handling and controlling the Bluetooth signal and the USB interface signal. Then, it is determined whether the connection is disconnected (step 522). If it is disconnected, a signal of pulling out the USB interface is sent directly (step 524) and file transmission is stopped. If it is not disconnected, step 504, determining the intention to receive or send the file, is returned.

In addition, when the computer intends to be connected to the Bluetooth mobile phone so as to send files or a data stream with other formats, e.g., the mobile phone receives the FTP data in USB interface format from the host system (step 506), the conversion program of the Bluetooth signal transmission module will identify and convert the data into a Bluetooth signal in FTP data format, and the Bluetooth module of the Bluetooth signal transmission module will send this FTP data format to the mobile phone (step 510) and establish file connection mode with the mobile phone (step 512). Then, it will be determined whether the connection is disconnected (step 522). If it is disconnected, the signal of pulling out from USB interface 524 is sent directly and data receiving is stopped. If it is not disconnected, step 504, determining the intention to receive or send data, is returned. The subsequent steps are repeated as mentioned above, and therefore the detailed descriptions are omitted herein.

Furthermore, being connected to a Bluetooth mouse of human-interface device (HID) type, by clicking the request button of the Bluetooth mouse, the data stream in standard Bluetooth format HCI (Host Controller Interface) will be completely converted and reorganized into a data stream in USB format (part of the data is similar to that in USB interface format, for example, they both have XY coordinate variation value) that is reported to the host system to perform file transmission and exchange. In addition, other applicable wireless techniques such as Wi-Fi, ZigBee and other wireless techniques, or a connection of IEEE1394, RS232 wired interface can be suitable in the system of the present invention and be used in the embodiment of the present invention according to the protocol.

The above-described embodiments of the present invention are intended to be illustrative only. Numerous alternative embodiments may be devised by those skilled in the art without departing from the scope of the following claims.

What is claimed is:

1. A method of wireless signal transmission used to establish data transmission with a host system, comprising the steps of:
connecting a receiving data stream in the first format of a computer peripheral;
identifying the type of the computer peripheral based on the receiving data stream in the first format; and
reporting the type of the computer peripheral to the host system with a predetermined signal through the wired interface port.

2. The method of claim 1, further comprising the steps of:
converting the receiving data stream in the first format into a receiving data stream in a second format; and
transmitting the receiving data stream in the second format to the host system through the wired interface port.

3. The method of claim 1, further comprising the steps of:
receiving a sending data stream in the second format from the host system through the wired interface port,
converting the sending data stream in the second format into a sending data stream in the first format; and
transmitting the sending data stream in the first format to the computer peripheral.

4. The method of claim 2, further comprising the step of:
sending a signal of inserting a wired interface if the receiving data stream in the first format is converted into the receiving data stream in the second format.

5. The method of claim 1, further comprising the step of:
sending a signal of pulling out the wired interface to the host system, when the connection of the receiving data stream in the first format is disconnected.

6. The method of claim 3, wherein the signal format of the receiving or sending data stream in the first format is in compliance with Bluetooth protocol.

7. The method of claim 3, wherein the signal format of the receiving or sending data stream in the first format is in compliance with ZigBee protocol.

8. The method of claim 1, wherein the wired interface port is a USB port.

9. The method of claim 1, wherein the wired interface port is an IEEE1394 port.

10. The method of claim 1, wherein the computer peripheral is selected from the group consisting of:
a printer;
a scanner;
a mobile;
a computer;
a mouse;
a keyboard;
a digital camera;
a personal data assistant (PDA);
an earphone; and
an information appliance (IA).

11. The method of claim 1, wherein the host system is selected from the group consisting of:
a desktop computer;
a laptop; and
a personal data assistant (PDA).

12. A wireless signal transmission system used to establish data transmission between a computer peripheral and a host system, comprising:
a wireless module configured to receive a data stream in a wireless format;
a processor coupled to the wireless module and having a conversion program; the conversion program identifies the type of the computer peripheral based on the data stream in the wireless format; and
a wired interface port electrically connected to the processor, wherein the conversion program reports the type of the computer peripheral to the host system with a predetermined signal through the wired interface port.

13. The system of claim 12, wherein the conversion program converts the data stream in the wireless format into a data stream in a wired format, and transmits the data stream in the wired format to the host system through the wired interface port.

14. The system of claim 12, wherein the processor receives a sending data stream in a wired format from the host system through the wired interface port.

15. The system of claim 14, wherein the conversion program converts the sending data stream in the wired format into a sending data stream in a wireless format, and transmits the sending data stream in the wireless format to the computer peripheral through the wireless module.

16. The system of claim 13, wherein a signal of inserting a wired interface is sent to the host system when the data stream in the wireless format is converted into the data stream in the wired format.

17. The system of claim 12, wherein a signal of pulling out the wired interface is sent to the host system when the connection between the processor and the wired interface port is disconnected.

18. The system of claim 12, wherein the wireless module is in compliance with Bluetooth protocol.

19. The system of claim 12, wherein the wireless module is in compliance with ZigBee protocol.

20. The system of claim 12, wherein the wired interface port is a USB port.

21. The system of claim 12, wherein the wired interface port is in compliance with IEEE1394.

22. The system of claim 12, wherein the computer peripheral is selected from the group consisting of:
a printer;
a scanner;
a mobile phone;
a computer;
a mouse;
a keyboard;
a digital camera;
a personal data assistant (PDA);
an earphone; and
an information appliance (IA).

23. The system of claim 12, wherein the host system is selected from the group consisting of:
a desktop computer;
a laptop; and
a personal data assistant (PDA).

24. A wireless signal transmission system used to establish data transmission between a computer peripheral and a host system, comprising:
a processor receiving a data stream in a wireless format in a remote access manner and having a conversion program configured to identify the type of the computer peripheral based on the data stream in the wireless format; and
a wired interface port electrically connected to the processor, wherein the conversion program reports the type of the computer peripheral to the host system with a predetermined signal through the wired interface.

25. The system of claim 24, wherein the conversion program converts the data stream in the wireless format into a data stream in a wired format, and transmits the data stream in the wired format to the host system through the wired interface port.

26. The system of claim 24, wherein the processor receives a sending data stream in a wired format from the host system through the wired interface port.

27. The system of claim 26, wherein the conversion program converts the sending data stream in the wired format into a sending data stream in a wireless format, and transmits the sending data stream in the wireless format to the computer peripheral through a wireless module.
